(19) United States
(12) Patent Application Publication
(10) Pub. No.: US 2017/0070728 A1
(43) Pub. Date: Mar. 9, 2017

(54) MULTIVIEW IMAGE DISPLAY APPARATUS AND CONTROL METHOD THEREOF

(71) Applicant: SAMSUNG ELECTRONICS CO., LTD., Suwon-si (KR)

(72) Inventors: Byung-moo KIM, Seoul (KR); Tae-hun HA, Suwon-si (KR)

(73) Assignee: SAMSUNG ELECTRONICS CO., LTD., Suwon-si (KR)

(21) Appl. No.: 15/142,551

(22) Filed: Apr. 29, 2016

(30) Foreign Application Priority Data
Sep. 7, 2015 (KR) 10-2015-0126242

(51) Int. Cl. H04N 13/04

(52) U.S. Cl. CPC H04N 13/0404; H04N 13/0422; H04N 13/0409

(57) ABSTRACT

A multiview image display apparatus includes a display including a display panel configured to repeatedly arrange at least two images having different views and a visual field divider configured to provide different views, a sensor configured to sense a temperature, and a processor configured to adjust a depth value between the at least two images having the different views based on the sensed temperature to provide different views at a preset viewing distance from the display.

### CROSS-REFERENCE TO RELATED APPLICATIONS

This application claims priority from Korean Patent Application No. 10-2015-0126242, filed on Sep. 7, 2015, in the Korean Intellectual Property Office, the disclosure of which is incorporated herein by reference in its entirety.

### BACKGROUND

Field

Apparatuses and methods consistent with exemplary embodiments relate to a 3-dimensional (3D) image display apparatus and a control method thereof, and more particularly, to a multiview image display apparatus and a control method thereof.

Description of the Related Art

Due to the advancement of electronic technologies, various types of electronic devices have been developed. In particular, display apparatuses, such as consumer televisions, have been rapidly developed.

As quality of display apparatuses has improved, types of contents displayed on the display apparatus have been variously increased. For example, a stereoscopic display system that enables a 3-dimensional (3D) content to be viewed has been developed and distributed.

Stereoscopic display apparatuses may be realized as various types of display apparatuses such as 3D TVs used in a home, various types of monitors, a portable phone, a personal digital assistant (PDA), a set-top personal computer (PC), a tablet PC, an electronic frame, a kiosk PC, etc. Also, 3D display technology may be used in various fields related to 3D imaging such as science, medicine, design, education, advertisement, computer games, etc.

A stereoscopic display system may be classified as a glasses-free system that enables viewing without glasses or a glasses type system that enables viewing with glasses.

The glasses type system may provide a satisfactory 3D effect but may force a user to use glasses. However, the glasses-free system enables viewing of a 3D image without glasses.

### SUMMARY

Exemplary embodiments may overcome the above disadvantages and other disadvantages not described above. Also, an exemplary embodiment is not required to overcome the disadvantages described above, and an exemplary embodiment may not overcome any of the problems described above.

One or more exemplary embodiments provide a multiview image display apparatus for providing a clear 3-dimensional (3D) image through 3D rendering reflecting a temperature of the multiview image display apparatus, and a control method thereof.

According to an aspect of an exemplary embodiment, there is provided a multiview image display apparatus including: a display including: a display panel configured to repeatedly arrange at least two images having different views; and a visual field divider disposed on a front surface of the display panel, the visual field divider configured to provide different views; a sensor configured to sense a temperature; and a processor configured to adjust a depth value between the at least two images having the different views based on the sensed temperature to provide the different views at a preset viewing distance from the multiview image display apparatus.

The apparatus may include a memory configured to store a table including a depth value set according to the viewing distance at which the different views may be provided based on an expansion or a contraction of the visual field divider caused by a temperature change, and the processor may adjust the depth value between the at least two images based on the table stored in the memory.

The table may include a depth correction value that corresponds to each grayscale value of each sub-pixel of a plurality of sub-pixels forming the at least two images having the different views and that may be set according to the temperature.

The apparatus may include a backlight disposed on a back surface of the display panel configured to provide light to the display panel, wherein the sensor may be configured to sense a temperature generated by heat generated by the backlight.

The apparatus may include laser sensors disposed on a left side and a right side of a light guide plate of the backlight and configured to generate laser beams, wherein the depth value may be determined based on a modification degree of the light guide plate sensed by the laser sensors and the temperature sensed by the sensor.

The visual field divider may be a parallax barrier or a lenticular lens, wherein the table stored in the memory may be a depth value set in consideration of the viewing distance at which the different views may be provided based on an expansion or a contraction of the parallax barrier or an expansion or a contraction of the lenticular lens caused by a temperature change.

According to an aspect of an exemplary embodiment, there is provided a method of controlling a multiview image display apparatus including a display panel configured to repeatedly arrange at least two images having different views and a visual field divider configured to be disposed on a front surface of the display panel configured to provide different views, the method including: sensing an internal temperature of the multiview image display apparatus; and adjusting a depth value between the at least two images having the different views based on the sensed temperature to display a multiview image to provide the different views at a preset viewing distance from the multiview image display apparatus.

The method may include storing a table including a depth value set according to the viewing distance at which the different views may be provided based on an expansion or a contraction of the visual field divider caused by a temperature change, wherein the displaying of the multiview image may include adjusting the depth value between the at least two images based on the stored table.

The table may include a depth correction value that corresponds to each grayscale value of each sub-pixel of a plurality of sub-pixels forming the at least two images having the different views and that may be set according to a temperature.

The method may include providing light to the display panel with a backlight disposed on a back surface of the display panel; and sensing the internal temperature by sensing heat generated by the backlight.

The method may include generating laser beams by using laser sensors disposed on a left side and a right side of a light guide plate of the backlight; and determining the depth value based on a modification degree of the light guide plate sensed by the laser sensors and the sensed temperature.

The table may include a depth value set according to the viewing distance at which the different views may be provided based on an expansion or a contraction of a parallax barrier or an expansion or a contraction of a lenticular lens caused by a temperature change.

According to an aspect of an exemplary embodiment, there is provided a display apparatus including: a display configured to display a first view and a second view to a user at a predetermined viewing distance; a sensor configured to sense a temperature; a processor configured to adjust a depth value corresponding to a distance between the first view and the second view, according to the sensed temperature.

The sensor may include a first laser sensor disposed at a first end of a light guide plate and a second laser sensor disposed at a second end of the light guide plate, and wherein the depth value may be determined by the first laser sensor and the second laser according to a shape of the light guide plate.

The apparatus may include a table configured to store a plurality of depth correction values corresponding to a grayscale value of the first view and a grayscale value of the second view.

The depth value may be determined according to the predetermined viewing distance and the sensed temperature.

The depth value may be determined according to the predetermined viewing distance and an expansion or contraction of a parallax barrier.

According to one or more exemplary embodiments, an image quality of a 3-dimensional (3D) image provided from a multiview image display system may be improved.

Additional aspects and/or advantages of exemplary embodiments will be set forth in part in the description that follows and/or may be learned by practice of exemplary embodiments.

### BRIEF DESCRIPTION OF THE DRAWINGS

The above and/or other aspects will be more apparent by the description of exemplary embodiments with reference to the accompanying drawings, in which:

FIGS. 1A and 1B illustrate an operation of a multiview image display apparatus according to an exemplary embodiment;

FIGS. 2A through 2D illustrate a configuration of a multiview image display apparatus, according to one or more exemplary embodiments;

FIGS. 3A through 4C illustrate a distortion phenomenon occurring due to heat of a multiview image display apparatus, according to an exemplary embodiment;

FIGS. 5A through 5C illustrate a method of setting a depth value of a multiview image display apparatus, according to an exemplary embodiment;

FIGS. 6A and 6B illustrate a method of adjusting a depth value to adjust a viewing distance, according to an exemplary embodiment;

FIGS. 7A and 7B illustrate a depth value table acquired by experimentation, according to an exemplary embodiment; and

FIG. 8 is a flowchart of a method of controlling a multiview image display apparatus, according to an exemplary embodiment.

### DETAILED DESCRIPTION OF EXEMPLARY EMBODIMENTS

Exemplary embodiments will be described below in greater detail with reference to the accompanying drawings.

In the description below, same drawing reference numerals are used for the same elements even in different drawings. The matters defined in the description, such as detailed construction and elements, are provided to assist in a comprehensive understanding of exemplary embodiments.

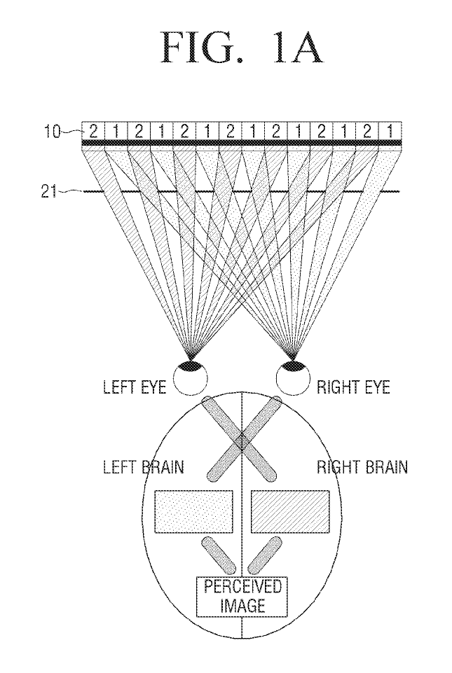

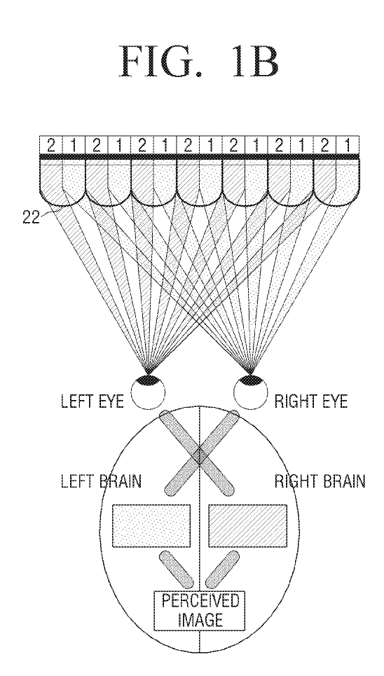

FIGS. 1A and 1B illustrate an operation of a multiview image display apparatus, according to an exemplary embodiment.

FIGS. 1A and 1B illustrate an operation method of an apparatus that displays a multiview image to provide a 3-dimensional (3D) image according to a glasses-free method. Here, the multiview image includes a plurality of images that are acquired by capturing an object at different angles. The plurality of images that are captured at the different angles are refracted at different angles, and an image that is focused at a preset distance (e.g., 3 m), referred to as a viewing distance, is provided. A location at which such an image is formed is referred to as a viewing zone (i.e., an optical view). Therefore, if one of the eyes of a user is located in a first viewing zone, and the other one of the eyes of the user is located in a second viewing zone, the user may feel a 3-dimensional (3D) effect.

For example, FIGS. 1A and 1B illustrate a display operation of a multiview image having a total of two views. Referring to FIGS. 1A and 1B, the multiview image display apparatus may display a multiview image having two views on a display panel 10. Also, a parallax barrier 21 of FIG. 1A, and a reticular lens 22 of FIG. 1B, may enable light corresponding to a first view image of two views to be projected onto a left eye of the user and light corresponding to a second view image of the two views to be projected onto a right eye of the user. Therefore, the user may view images having different views with the left and right eyes to feel a 3D effect.

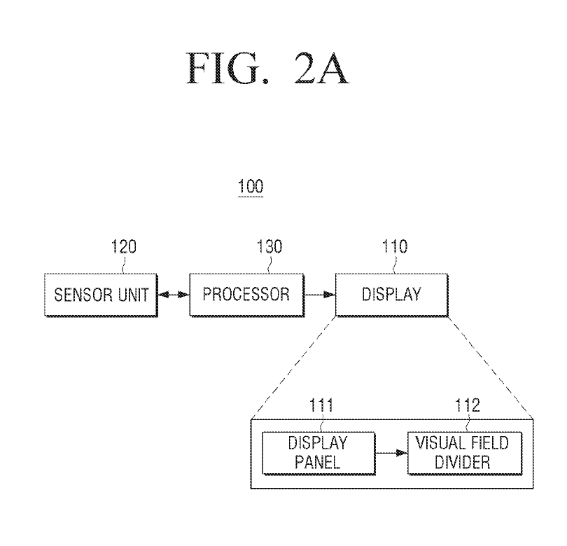

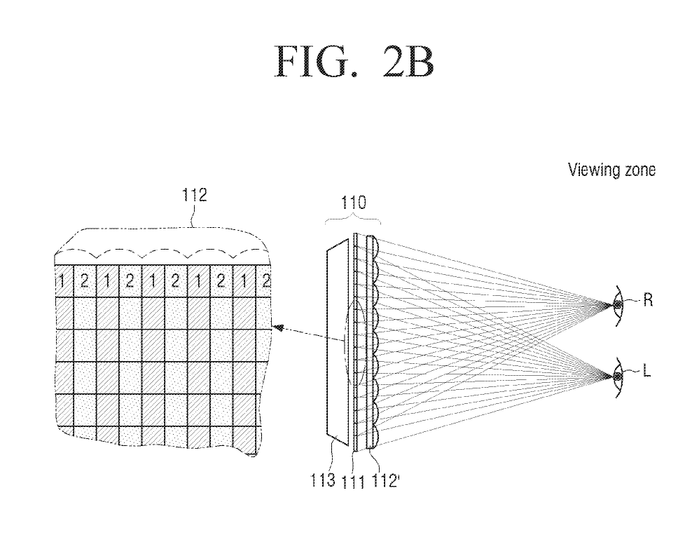

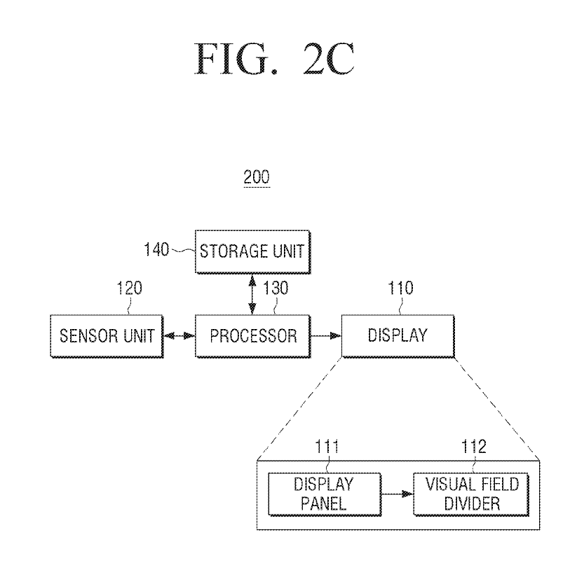

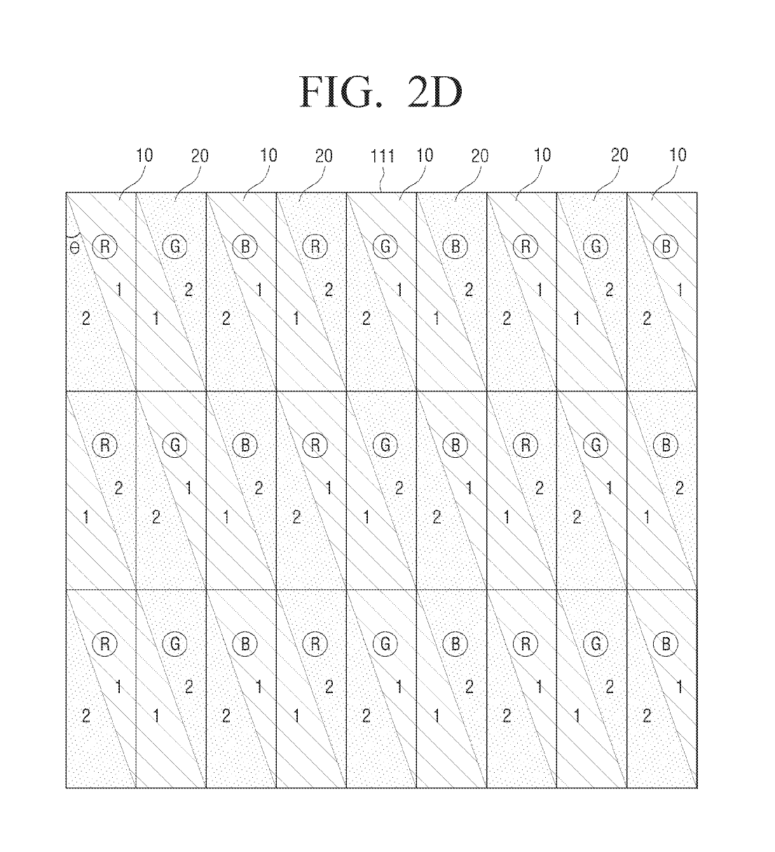

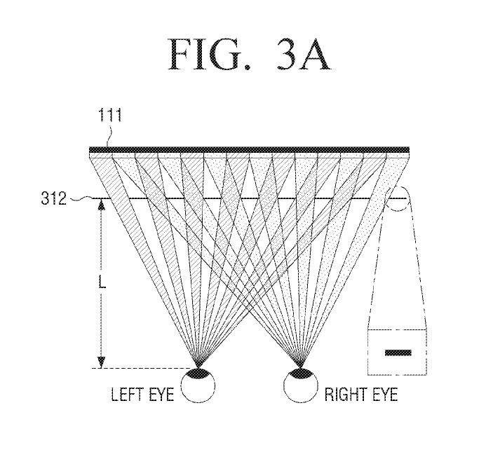

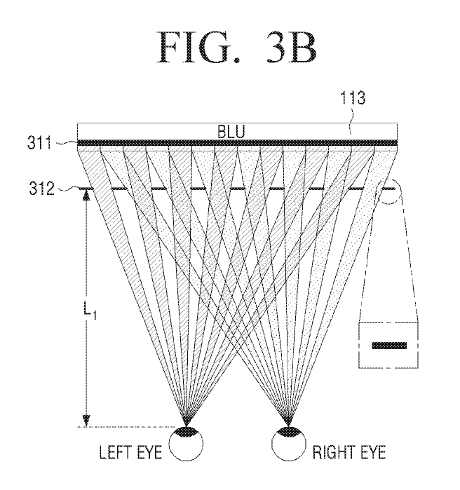

FIGS. 2A through 2D illustrate a configuration of a multiview image display apparatus, according to one or more exemplary embodiments.

FIG. 2A is a block diagram of a configuration of a multiview image display apparatus 100, according to an exemplary embodiment.

Referring to FIG. 2A, the multiview image display apparatus 100 includes a display 110, a sensor unit 120 (e.g., sensor), and a processor 130.

The multiview image display apparatus 100 may be realized as various types of display apparatuses such as a TV, a monitor, a PC, a kiosk PC, a tablet PC, an electronic frame, a portable phone, etc.

An image input unit (e.g., input interface) receives an image. In detail, the image input unit may receive the image from various types of external apparatuses such as an external storage medium, a broadcasting station, a web server, etc. Here the received image is one of a single view image, a stereoscopic image, and a multiview image. The single view image is an image that is captured by a photographing apparatus. The stereoscopic image is a 3D video image that is expressed with left and right eye images and is a 3D image that is captured by a stereoscopic photographing apparatus. The stereoscopic photographing apparatus is used to capture a 3D image with a photographing apparatus including two lenses. The multiview image refers to a 3D video image that geometrically corrects images captured through one or more photographing apparatuses and provides various views of several directions to a user through a spatial synthesis, etc.

The image input unit may also receive depth information of the image. A depth of the image may include a depth value that is allocated to each of pixels of the image. For example, the image may have a grayscale value between 0 and 255. When the depth is expressed as black and/or white, a black color (e.g., a low value) indicates a place distant from a viewer, and a white color (e.g., a high value) indicates a place close to the viewer.

According to an exemplary embodiment, the depth information is information indicating a depth of a 3D image, i.e., information corresponding to a binocular disparity degree between left and right eye images forming the 3D image. A degree of a 3D effect felt by a person varies according to the depth information. In other words, if the depth is large, a binocular disparity becomes larger, and thus the 3D effect is felt more. If the depth is small, the binocular disparity is small, and the 3D effect is felt less. The depth information may be acquired through a passive method of acquiring depth information with a 2-dimensional (2D) characteristic of an image such as stereo matching and an active method using an apparatus such as a depth camera. The depth information may be a depth map.

The depth map refers to a table including depth information of each area of the image. Areas may be divided according to pixels or may be defined as preset areas larger than pixel units. For example, the depth map may indicate a value smaller than 127 or 128 as a minus value and a value greater than 127 or 128 as a plus value by using 127 or 128 of grayscale values between 0 and 255 as a reference value, e.g., 0 (or a focal plane). A reference value of the focal plane may be arbitrarily selected between 0 and 255. Here, the minus value refers to sinking, and the plus value refers to projection.

The display 110 provides a multiview (or a multi-optical view). For this, the display 110 includes a display panel 111 and a visual field divider 112 for providing the multiview.

The display panel 111 includes a plurality of pixels, each including a plurality of sub-pixels. Here, the sub-pixels may include red (R), green (G), and blue (B) sub-pixels. In other words, pixels including R, G, and B sub-pixels may be arranged in a plurality of rows and a plurality of columns to form the display panel 111. The display panel 111 may be realized as various types of display units such as a Liquid Crystal Display (LCD) panel, a Plasma Display Panel (PDP), an Organic Light-Emitting Diode (OLED), a Vacuum Fluorescent Display (VFD), a Field Emission Display (FED), an Electro-Luminescent Display (ELD), etc.

The display panel 111 displays an image frame. In detail, the display panel 111 may display the image frame for which a plurality of images having different views are sequentially repeatedly arranged.

If the display panel 111 is realized as an LCD panel, the multiview image display apparatus 100 may further include a backlight unit (e.g., backlight) that supplies backlight to the display panel 111 and a panel driver that drives pixels of the display panel 111 according to pixel values of pixels forming the image frame.

The visual field divider 112 may be disposed on a front surface of the display panel 111 to provide different views according to viewing zones, e.g., a multiview. According to an exemplary embodiment, the visual field divider 112 may be realized as a lenticular lens or a parallax barrier.

According to an exemplary embodiment, the visual field divider 112 may be realized as a lenticular lens including a plurality of lens areas. The lenticular lens may refract an image displayed on the display panel 111 through the plurality of lens areas. Each of the lens areas may be formed in a size corresponding to at least one pixel to disperse light penetrating through each pixel according to viewing zones.

According to an exemplary embodiment, the visual field divider 112 may be realized as a parallax barrier. The parallax barrier is realized as a transparent slit array including a plurality of barrier areas. Therefore, the parallax barrier interrupts light through slits between the barrier areas to emit an image having different views according to viewing zones.

FIG. 2B illustrates a visual field divider 112 that is realized as a lenticular lens array, according to an exemplary embodiment.

Referring to FIG. 2B, the display 110 includes the display panel 111, a lenticular lens array 112′, and a backlight unit 113.

Referring to FIG. 2B, the display panel 111 includes a plurality of pixels that are arranged in a plurality of columns. Images having different views are respectively arranged in the columns. Referring to FIG. 2D, a plurality of images 1 and 2 having different views are sequentially and repeatedly arranged. In other words, each pixel area is formed as a group numbered from 1 to 2. A graphic signal applied to the display panel 111 is arranged so that pixel column 1 displays a first image, and pixel column 2 displays a second image.

The backlight unit 113 provides light to the display panel 111. Through the light provided from the backlight unit 113, images 1 and 2 formed on the display panel 111 are projected onto the lenticular lens array 112′, and the lenticular lens array 112′ disperses lights of the projected images 1 and 2 to transmit the lights toward a viewer. In other words, the lenticular lens array 112′ generates exit pupils in a location of the viewer, i.e., at a viewing distance. As shown in FIG. 2B, if a visual field divider is realized as a lenticular lens array or a parallax barrier, a thickness and a diameter of a lenticular lens, or a distance between slits, etc., may be designed to enable exit pupils generated by columns to be separated from each other at an average binocular center distance less than 65 mm. Separated image lights respectively form viewing zones. In other words, as shown in FIG. 2B, if a first view and a second view are formed in preset locations, and left and right eyes of a user are respectively located in the first view and the second view, the user may view a 3D image.

The visual field divider 112 may incline at a preset angle to operate to improve an image quality. The processor 130 may divide multiview images based on the angle at which the visual field divider 112 inclines and combine the divided images to generate an image frame. Therefore, the user may view an area inclining in a particular direction not an image displayed in vertical or horizontal direction with respect to a sub-pixel of the display panel 111. As a result, the viewer may view a portion of each sub-pixel rather than a complete sub-pixel. For example, when a total of 2 views are provided, an output image may be rendered to enable at least some of a plurality of sub-pixels to respectively output pixel values corresponding to a plurality of multiview images as shown in FIG. 2D. In this case, if a right eye of the viewer views a first view image, and a left eye of the viewer views a second view image, the right eye of the viewer may view an inclined area 10 corresponding to a first view, and the left eye of the viewer may view an inclined area 20 corresponding to a second view. Here, a rendering image is exemplarily illustrated in FIG. 2D, and thus the number of multiview images, a rendering pitch, etc., may be variously changed according to exemplary embodiments.

The sensor unit 120 is disposed in the multiview image display apparatus 100 to sense a temperature of the multiview image display apparatus 100. The temperature sensed by the sensor unit 120 may be heat generated from a backlight unit, an ambient temperature, etc.

The processor 130 controls an overall operation of the multiview image display apparatus 100.

According to an exemplary embodiment, the processor 130 may control to adjust a depth value between at least two images having different views based on the temperature sensed by the sensor unit 120 to provide optical views having different views at a preset viewing distance from the display 110.

In this case, if an input image is a 2D image, the processor 130 may generate two views (i.e., a left eye image and a right eye image) based on depth information extracted through a 2D and/or 3D conversion. However, if a multiview, i.e., two views (e.g., a left eye image and a right eye image), and two pieces of depth information corresponding to the multiview are input, the processor 130 may use a corresponding image and depth information. If only the multiview, i.e., the two views (e.g., the left eye image and the right eye image), is input, the processor 130 may extract depth information from the two views and use the extracted depth information.

The processor 130 may display a multiview image including two images having different views on the display panel 111 to provide a 3D image through the visual field divider 112 at a particular viewing distance. The display 110 including the display panel 111 and the visual field divider 112 may be modified according to a temperature to enable an optical view not to be provided at a preset viewing distance.

For example, due to heat generated from the backlight unit 113 in a structure shown in FIG. 2B, light may be diffracted and/or refracted on a path different than an initial optical design. Therefore, accurate images may not be transmitted to the left and right eyes of the user, and thus crosstalk may occur. For example, due to heat generated from the backlight unit 113, a parallax barrier or a lenticular lens is heated and expanded to move an optical focus. The optical focus may move due to a contraction of the parallax barrier or the lenticular lens.

Therefore, the processor 130 may adjust a depth of a displayed image to reduce the crosstalk occurring due to the modification of the display 110 caused by the temperature.

In detail, the processor 130 adjusts a depth of a displayed image having different views based on a sensed temperature.

In this case, the processor 130 may calculate a depth value that is changed according to a temperature through a preset algorithm but may adjust a depth of a displayed image having different views based on depth information depending on a pre-stored temperature.

FIG. 2C is a block diagram of a configuration of a multiview image display apparatus 200, according to another exemplary embodiment.

Referring to FIG. 2C, the multiview image display apparatus 200 includes a display 110, a sensor unit 120, a processor 130, and a storage unit 140 (e.g., memory). The display 110, the sensor unit 120, and the processor 130 of FIG. 2C are similar to the display 110, the sensor unit 120, and the processor 130 of FIG. 2A.

The storage unit 140 may store depth information depending on a temperature. Here, the depth information depending on the temperature is calculated through experimentation. Therefore, although the temperature changes, the depth information may be a depth value at which an optical view is provided at a viewing distance preset in an initial optical design.

The storage unit 140 may also store depth information of each grayscale at a particular temperature. The storage unit 140 may store a table including a depth value set in consideration of a viewing distance at which an optical view having different views (e.g., a left eye image and a right eye image) is provided based on an expansion or a contraction of a lenticular lens or a parallax barrier caused by changes in a temperature.

For example, the storage unit 140 may store a table including a depth correction value that corresponds to each grayscale value of each of sub-pixels forming at least two images having different views and that is set according to a temperature.

The multiview image display apparatus 100 or 200 according to an exemplary embodiment may be realized to provide an optical view enabling 3D viewing in a particular viewing location of a particular viewing distance. According to another exemplary embodiment, the multiview image display apparatus 100 or 200 may be realized to provide an optical view enabling 3D viewing even in any location of a particular viewing distance (e.g., a horizontal location). In the former case, an optical view enabling 3D viewing may be provided in a particular viewing location by using an image providing two different views. However, in the latter case, an optical view enabling 3D viewing may be provided in any location by using an image providing two or more different views, e.g., 35 different views.

In the latter case, the processor 130 may render necessary N views based on a type of an input image. For example, the processor 130 may select a 3D image, i.e., one of left and right eye images, as a reference view (or a center view) to generate a leftmost view and a rightmost view of a multiview image. In this case, the processor 130 may generate the leftmost and rightmost views based on corrected depth information corresponding to one of the left and right eye images selected as the reference view.

If the leftmost and rightmost views are generated, the processor 130 may generate a plurality of interpolation views between the center view and the leftmost view and generate a plurality of interpolation views between the center view and the rightmost view to render the multiview image. However, the processor 130 is not limited thereto and may generate an extrapolation view through extrapolation. If a multiview image is rendered based on a 2D image and depth information, the 2D image may be selected as a center view.

The above-described rendering operation is merely an example, and a multiview image may be rendered by using various methods besides the above-described operation.

If the display panel 111 is realized as an LCD panel, the multiview image display apparatus 200 may further include a backlight unit that is disposed on a back surface of the display panel 111 to provide light to the display panel 111. In this case, the sensor unit 120 may sense a temperature occurring due to heat generated by the backlight unit.

The multiview image display apparatus 200 may further include laser sensors that are disposed on left and right sides of a light guide plate of the backlight unit to generate laser beams on a plurality of steps that are separated from one another. In this case, a depth value of the table stored in the storage unit 140 may be calculated based on a modification degree of the light guide plate sensed by the laser sensors and a temperature sensed by the sensor unit 120.

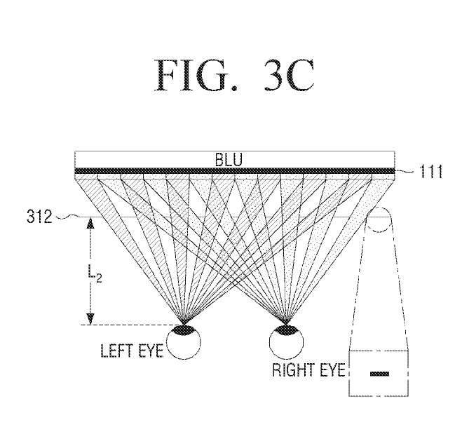

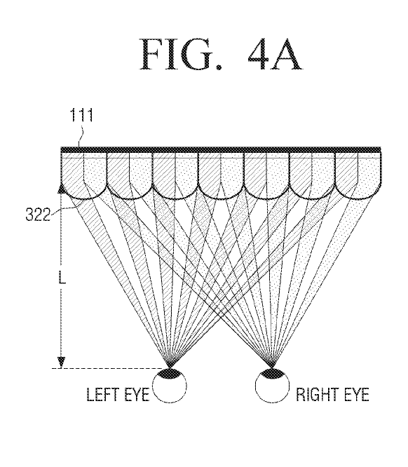

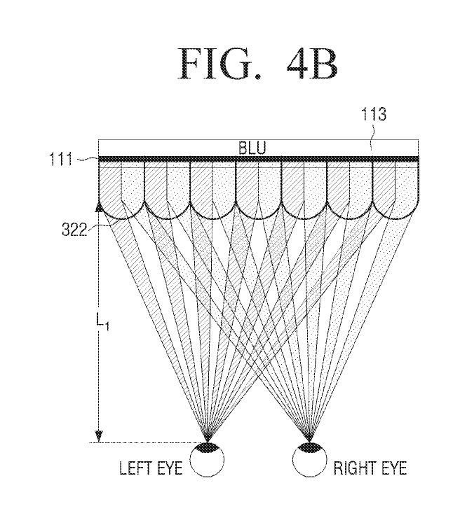

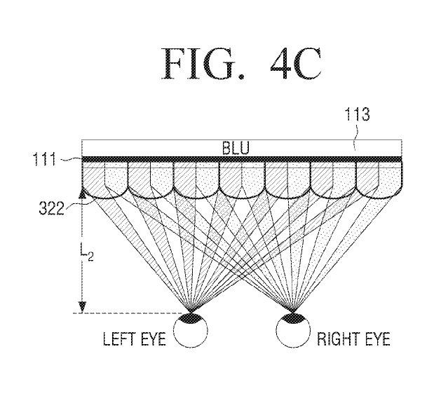

FIGS. 3A through 4C illustrate a distortion phenomenon occurring due to heat of a multiview image display apparatus, according to an exemplary embodiment.

FIG. 3A illustrates a visual field divider that is realized as a parallax barrier 312 and FIG. 4A illustrates the visual field divider that is realized as a lenticular lens 322. FIGS. 3A and 4A illustrate an optical view that is provided onto left and right eyes of a user at a viewing distance preset according to an optical design of the multiview image display apparatus.

As shown in FIGS. 3A and 4A, an optical view may be provided to the left and right eyes of the user at a viewing distance (e.g., a distance between a display and the visual field divider 312 or 322) preset according to an optical design of the multiview image display apparatus.

FIGS. 3B and 4B illustrate the parallax barrier 312 and the lenticular lens 322 that are heated and expanded due to heat generated from a backlight unit 113.

As shown in FIGS. 3B and 4B, if the parallax barrier 312 of FIG. 3B or the lenticular lens 322 of FIG. 4B is heated and expanded due to a temperature rise, an optical focus may move to provide an optical view behind a viewing distance preset according to an optical design. For example, an optical focus may be at a distance L₁ that is greater than a distance L.

FIGS. 3C and 4C illustrate the parallax barrier 312 and the lenticular lens 322 that are contracted due to a decrease in a temperature of the backlight unit 113.

As shown in FIGS. 3C and 4C, if the parallax barrier 312 or the lenticular lens 322 is contracted due to a temperature decline, an optical focus may move to provide an optical view in front of a viewing distance preset by an optical design. For example, an optical focus may be at a distance L₂ that is less than a distance L.

As described above, if the parallax barrier 312 or the lenticular lens 322 is expanded or contracted, light is diffracted and/or refracted on a path different than an initial optical design. Thus an optical view is not provided at a preset viewing distance. Therefore, accurate images are not provided onto left and/right eyes of the user, and 3D crosstalk may occur. Here, crosstalk may refer to a phenomenon in which a left eye image is combined with a right eye image and then seen by the right eye or the right eye image is combined with the left eye image and then seen by the left eye. A definition quality of a 3D image may be lowered due to crosstalk.

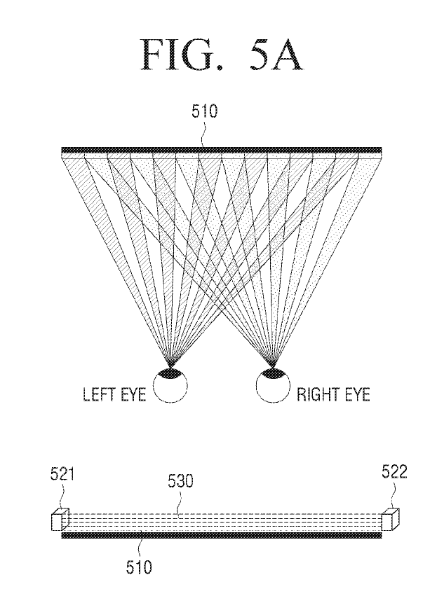

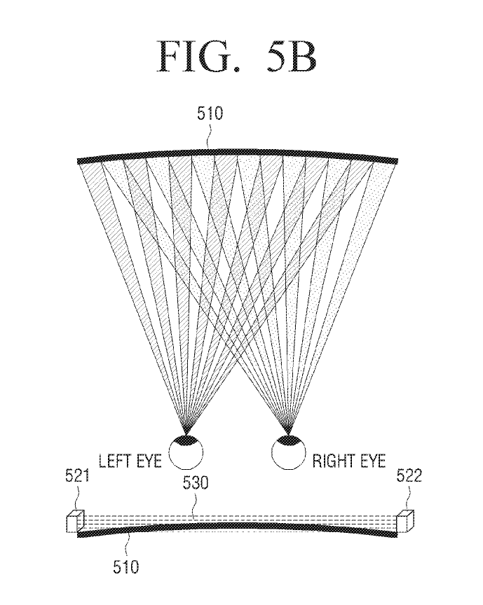

FIGS. 5A and 5B illustrate a method of setting a depth value of a multiview image display apparatus, according to an exemplary embodiment.

As shown in FIG. 5A, the multiview image display apparatus may include laser sensors 521 and 522 that are disposed on left and right sides of a light guide plate 510 of a backlight unit to generate laser beams 530 on a plurality of steps that are separated from one another. Here, the laser sensors 521 and 522 may sense a modification degree of the light guide plate 510 through the laser beams generated on the plurality of steps separated from one another.

For example, as shown in FIG. 5B, if the light guide plate 510 is heated and expanded due to a temperature rise, the modification degree of the light guide plate 510 may be sensed by the laser beams generated on the plurality of steps from the laser sensors 521 and 522.

A viewing distance that is formed according to an expansion and/or contraction of the parallax barrier 312 or the lenticular lens 322 corresponding to the modification degree of the light guide plate 510 sensed by the laser sensors 521 and 522 according to each temperature may be acquired by experimentation, and a depth value may be calculated to enable the acquired viewing distance to be a viewing distance preset by an optical design.

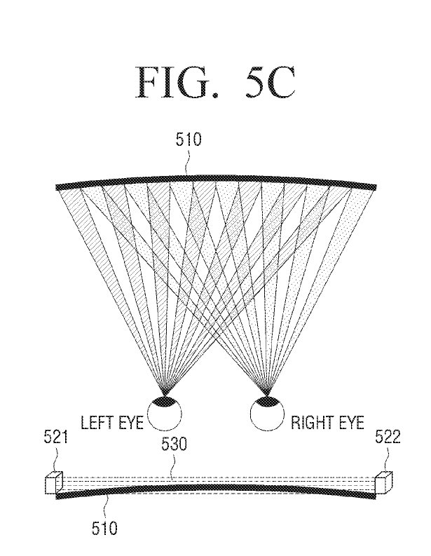

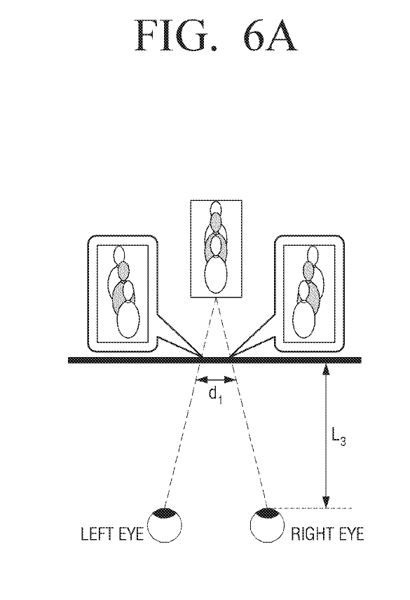

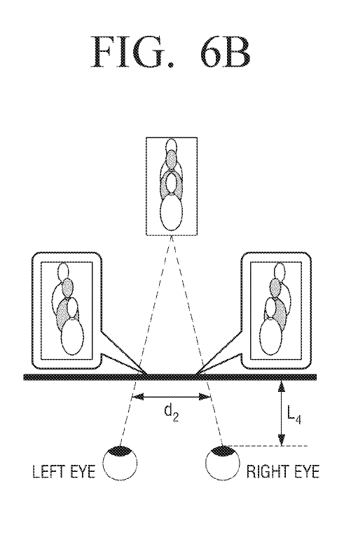

FIGS. 6A and 6B illustrate a method of adjusting a depth value to adjust a viewing distance, according to an exemplary embodiment.

As shown in FIG. 6A, if a depth value is d₁, an optical view is formed at a viewing distance L₃. As shown in FIG. 6B, if the depth value is changed into d₂, an optical view is formed at a viewing distance L₄ closer than the viewing distance L₃. In other words, because a depth value between left and right eye images corresponds to a viewing distance, the depth value between the left and right eye images may be appropriately rendered to adjust the viewing distance.

According to an exemplary embodiment, a depth value between left and right eye images may be adjusted to correct a viewing distance formed in an inappropriate location according to an expansion and/or contraction degree of the parallax barrier 312 or the lenticular lens 322 caused by a temperature change. Thus, image quality of a 3D image may be improved.

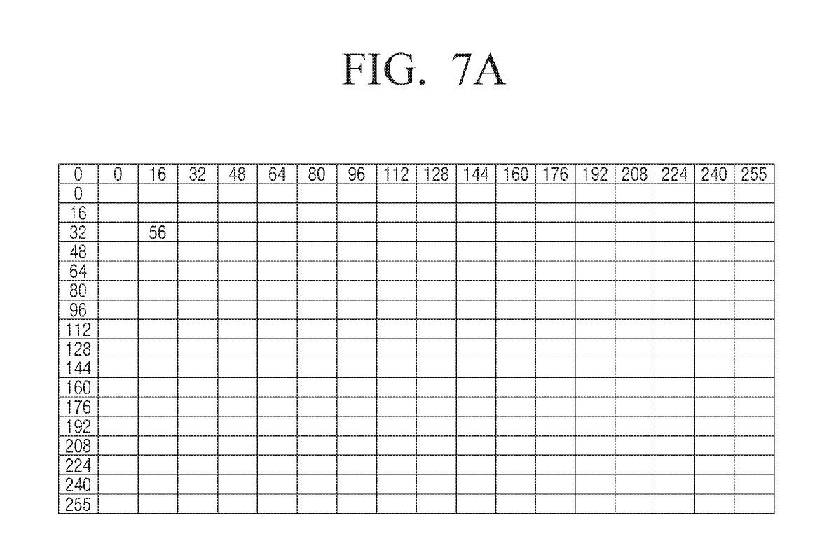

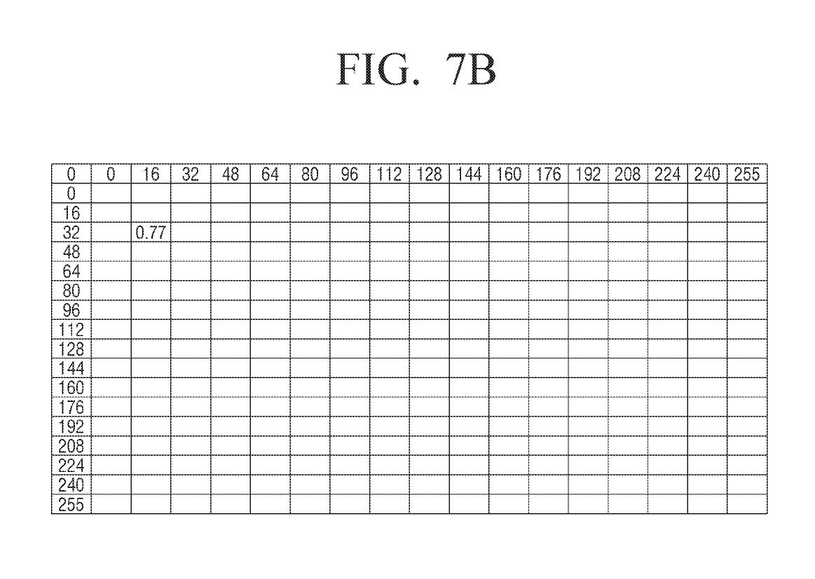

A table as shown in FIGS. 7A and 7B may be provided through the above-described method.

FIGS. 7A and 7B illustrate a table that may be stored in a storage unit, according to an exemplary embodiment.

FIG. 7A illustrates a table according to an exemplary embodiment. Here, a vertical line denotes data of a reference image (e.g., a left eye—a left image), and a horizontal line denotes data of a crosstalk image (e.g., the left eye—a right image). In this example, data 56 of an intersection between a grayscale of the reference image and a grayscale of the crosstalk image indicates that when the reference image (e.g., an image wanted to be seen) is grayscale 32, and grayscale 16 is input into the crosstalk image, a corrected output value, i.e., the reference image, is output as 56 that is a correction value in comparison with existing 32 to enable eyes of a human to recognize desired 32.

FIG. 7B illustrates a table according to another exemplary embodiment. Here, a vertical line denotes data of a left eye image, and a horizontal line denotes data of a right eye image. In this case, data 0.77 of an intersection between a grayscale of a left eye image and a grayscale of a right eye image may indicate a depth value that is to be corrected at a particular temperature when grayscale 32 is input into the left eye image, and grayscale 16 is input into the right eye image. For example, a depth value to be corrected according to each grayscale at a particular temperature may be stored.

However, the above-described exemplary embodiments are merely exemplary, and a depth value to be corrected at each temperature may be stored in various forms. For example, a depth value of an input image may be corrected according to a temperature to render a plurality of views.

Particular data is illustrated in FIGS. 7A and 7B, but corresponding data values may be included in other blanks where data is not written.

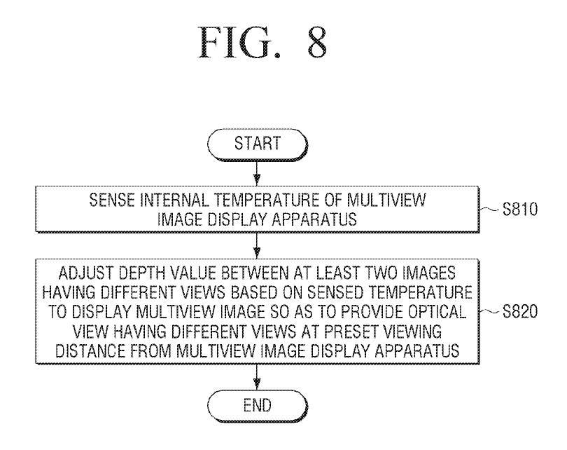

FIG. 8 is a flowchart of a method of controlling a multiview image display apparatus, according to an exemplary embodiment.

According to a method of controlling a multiview image display apparatus including a display panel in which at least two images having different views are repeatedly arranged and a visual field divider that is disposed on a front surface of the display panel to provide an optical view having different views as shown in FIG. 8, an internal temperature of the multiview image display apparatus is sensed in operation S810.

In operation S820, a depth value between the at least two images having the different views is adjusted based on the sensed temperature to display a multiview image to provide the optical view having the different views at a preset viewing distance from the multiview image display apparatus.

The multiview image display apparatus may store a table including a depth value set in consideration of the viewing distance at which the optical view having the different views is provided based on an expansion or a contraction of the visual field divider caused by a temperature change. Also, in operation S820, the depth value between the at least two images may be adjusted based on the stored table to display the multiview image.

The table may include a depth correction value corresponding to each grayscale value of each of sub-pixel forming at least two images having different views is set according to a temperature.

The multiview image display apparatus may further include a backlight unit that is disposed on a back surface of the display panel to provide light to the display panel. In operation S810, the internal temperature of the multiview image display apparatus may be sensed by heat generated by the backlight unit.

The multiview image display apparatus may also include laser sensors that are disposed on left and right sides of a light guide plate of the backlight unit to generate laser beams on a plurality of steps separated from one another. In this case, the stored depth value may be calculated based on a modification degree of the light guide plate sensed by the laser sensors and the temperature sensed in operation S810.

In this case, the visual field divider may be realized as a parallax barrier or a lenticular lens, and a table stored in a storage unit may include a depth value set in consideration of a viewing distance at which an optical view having different views are provided based on an expansion or a contraction of the parallax barrier or the lenticular lens caused by the temperature change.

According to one or more exemplary embodiments, a multiview image display apparatus may service a clear 3D image.

A method of controlling a multiview image display apparatus according to one or more exemplary embodiments may be embodied as a program and then provided to the multiview image display apparatus.

For example, there may be provided a non-transitory computer readable medium that stores a program performing sensing an internal temperature of a multiview image display apparatus and adjusting a depth value between at least two images having different views based on the sensed temperature to display a multiview image to provide an optical view having different views at a preset viewing distance from the multiview image display apparatus.

The non-transitory computer readable medium may be a medium that does not store data temporarily such as a register, cash, and memory but stores data semi-permanently and is readable by devices. The aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting. The exemplary embodiments can be readily applied to other types of apparatuses and methods. Also, the description of the exemplary embodiments is intended to be illustrative, and not to limit the scope of the claims; many alternatives, modifications, and variations will be apparent to those skilled in the art.

What is claimed is:

1. A multiview image display apparatus comprising:
a display comprising:
a display panel configured to repeatedly arrange at least two images having different views; and
a visual field divider disposed on a front surface of the display panel, the visual field divider configured to provide different views;
a sensor configured to sense a temperature; and
a processor configured to adjust a depth value between the at least two images having the different views based on the sensed temperature to provide the different views at a preset viewing distance from the multiview image display apparatus.

2. The multiview image display apparatus of claim 1, further comprising:
a memory configured to store a table comprising a depth value set according to the viewing distance at which the different views is provided based on an expansion or a contraction of the visual field divider caused by a temperature change,
wherein the processor adjusts the depth value between the at least two images based on the table stored in the memory.

3. The multiview image display apparatus of claim 2, wherein the table comprises a depth correction value that corresponds to each grayscale value of each sub-pixel of a plurality of sub-pixels forming the at least two images having the different views and that is set according to the temperature.

4. The multiview image display apparatus of claim 2, further comprising:
a backlight disposed on a back surface of the display panel configured to provide light to the display panel,
wherein the sensor is configured to sense a temperature generated by heat generated by the backlight.

5. The multiview image display apparatus of claim 4, further comprising:
laser sensors disposed on a left side and a right side of a light guide plate of the backlight and configured to generate laser beams,
wherein the depth value is determined based on a modification degree of the light guide plate sensed by the laser sensors and the temperature sensed by the sensor.

6. The multiview image display apparatus of claim 2, wherein the visual field divider is a parallax barrier or a lenticular lens,
wherein the table stored in the memory is a depth value set in consideration of the viewing distance at which the different views is provided based on an expansion or a contraction of the parallax barrier or an expansion or a contraction of the lenticular lens caused by a temperature change.

7. A method of controlling a multiview image display apparatus comprising a display panel configured to repeatedly arrange at least two images having different views and a visual field divider configured to be disposed on a front surface of the display panel configured to provide different views, the method comprising:
sensing an internal temperature of the multiview image display apparatus; and
adjusting a depth value between the at least two images having the different views based on the sensed temperature to display a multiview image to provide the different views at a preset viewing distance from the multiview image display apparatus.

8. The method of claim 7, further comprising:
storing a table comprising a depth value set according to the viewing distance at which the different views is provided based on an expansion or a contraction of the visual field divider caused by a temperature change,
wherein the displaying of the multiview image comprises adjusting the depth value between the at least two images based on the stored table.

9. The method of claim 8, wherein the table comprises a depth correction value that corresponds to each grayscale value of each sub-pixel of a plurality of sub-pixels forming the at least two images having the different views and that is set according to a temperature.

10. The method of claim 8, further comprising providing light to the display panel with a backlight disposed on a back surface of the display panel; and
sensing the internal temperature by sensing heat generated by the backlight.

11. The method of claim 10, further comprising:
generating laser beams by using laser sensors disposed on a left side and a right side of a light guide plate of the backlight; and
determining the depth value based on a modification degree of the light guide plate sensed by the laser sensors and the sensed temperature.

12. The method of claim 8, wherein the table comprises a depth value set according to the viewing distance at which the different views is provided based on an expansion or a contraction of a parallax barrier or an expansion or a contraction of a lenticular lens caused by a temperature change.

13. A display apparatus comprising:
a display configured to display a first view and a second view to a user at a predetermined viewing distance;
a sensor configured to sense a temperature;
a processor configured to adjust a depth value corresponding to a distance between the first view and the second view, according to the sensed temperature.

14. The display apparatus of claim 13, wherein the sensor comprises a first laser sensor disposed at a first end of a light guide plate and a second laser sensor disposed at a second end of the light guide plate, and
wherein the depth value is determined by the first laser sensor and the second laser according to a shape of the light guide plate.

15. The display apparatus of claim 13, further comprising a table configured to store a plurality of depth correction values corresponding to a grayscale value of the first view and a grayscale value of the second view.

16. The display apparatus of claim 13, wherein the depth value is determined according to the predetermined viewing distance and the sensed temperature.

17. The display apparatus of claim 13, wherein the depth value is determined according to the predetermined viewing distance and an expansion or contraction of a parallax barrier.
